(19) United States
(12) Patent Application Publication
(10) Pub. No.: US 2021/0132817 A1
(43) Pub. Date: May 6, 2021

(54) Relocation of Data in Memory At Different Transfer Rates Based on Temperature

(71) Applicant: WESTERN DIGITAL TECHNOLOGIES, INC., San Jose, CA (US)

(72) Inventors: Vinayak Bhat, Bangalore (IN); Raghavendra Gopalakrishnan, Bangalore (IN)

(21) Appl. No.: 16/670,105

(22) Filed: Oct. 31, 2019

(51) Int. Cl. G06F 3/06; G06F 11/30

(52) U.S. Cl. CPC G06F 3/0616; G06F 3/0647; G06F 3/0653; G06F 11/3058; G06F 3/0658; G06F 3/0644; G06F 3/0679

(57) ABSTRACT

Aspects of a storage device are provided which allow transfer of data between cells at higher transfer rates based on a temperature of the cells. The storage device includes a memory having a plurality of first and second cells. Each of the second cells are configured to store more bits than each of the first cells. A controller is configured to store data in the first cells in response to a write command from a host device. The controller is further configured to transfer the data from the first cells to the second cells at a higher transfer rate when a temperature of the second cells is above a temperature threshold than when below the temperature threshold.

### BACKGROUND

### Field

This disclosure is generally related to electronic devices and more particularly to storage devices.

### Background

Storage devices enable users to store and retrieve data. Examples of storage devices include non-volatile memory devices. A non-volatile memory generally retains data after a power cycle. An example of a non-volatile memory is a flash memory, which may include array(s) of NAND cells on one or more dies. Flash memory may be found in solid-state devices (SSDs), Secure Digital (SD) cards, and the like.

A flash storage device may store data into the NAND cells of the flash memory. NAND cells may include single level cells (SLCs) or multiple level cells (MLCs). An example of a MLC is a quad level cell (QLC). Generally, the flash storage device may write data directly into pages of SLC blocks. However, data can only be erased in blocks of flash memory. Therefore, when a SLC block becomes full, the flash storage device may relocate the data into empty blocks through a garbage collection process to free up space in the flash memory. For example, the data may be relocated into blocks of QLCs (or other MLCs).

As data is stored and accessed, the temperature of the NAND cells may increase.

While flash storage devices generally have a large cross temperature operating range (e.g. −2 to 85° C.), the temperature range for reliably retaining data may be lower due to the sensitivity of data to temperature (e.g. 0-70° C.). For example, QLCs may have a maximum reliable temperature of only 70° C. To preserve system integrity of the data, temperature throttling may be applied to maintain the flash storage device in the reliable temperature range. For example, when the temperature of QLC blocks on multiple dies exceeds a certain temperature threshold (e.g. 70° C.), the flash storage device may disable parallel access to one or more dies to reduce the temperature back into the reliable temperature range. However, since SLCs may have a higher reliable operating temperature than QLCs (e.g. 95° C.), temperature throttling QLC blocks may inefficiently reduce access to SLC blocks on the same die. As a result, the system performance and user experience of the flash storage device may be reduced. Moreover, the flash storage device may effectively be restricted to an operating temperature range (e.g. 0-70° C.) lower than its product operating temperature range (e.g. −2 to 85° C.).

### SUMMARY

One aspect of a storage device is disclosed herein. The storage device includes a memory having a plurality of first and second cells. Each of the second cells are configured to store more bits than each of the first cells. The storage device further includes a controller configured to store data in the first cells in response to a write command from a host device. The controller is further configured to transfer the data from the first cells to the second cells at a higher transfer rate when a temperature of the second cells is above a temperature threshold than when below the temperature threshold.

Another aspect of a storage device is disclosed herein. The storage device includes a memory having a plurality of first and second cells. Each of the second cells are configured to store more bits than each of the first cells. The storage device further includes a controller configured to store data in the first cells in response to a write command from a host device. The controller is further configured to transfer the data from the first cells to the second cells at a first transfer rate when a temperature of the second cells is below a temperature threshold and at a second transfer rate higher than the first transfer rate when the temperature is above the temperature threshold.

A further aspect of a storage device is disclosed herein. The storage device includes a memory having a plurality of first and second cells. Each of the second cells are configured to store more bits than each of the first cells. The storage device further includes a controller configured to store data in the first cells in response to a write command from a host device. The controller is further configured to transfer the data from the first cells to the second cells at a transfer rate. The transfer rate is a function of a temperature of the second cells.

It is understood that other aspects of the storage device will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of the present invention will now be presented in the detailed description by way of example, and not by way of limitation, with reference to the accompanying drawings, wherein:

FIG. 1 is a block diagram illustrating an exemplary embodiment of a storage device in communication with a host device.

FIG. 2 is a conceptual diagram illustrating an example garbage collection process in which data is relocated from an SLC block to a QLC block in the storage device of FIG. 1.

FIG. 3 is a conceptual diagram illustrating an example of a logical-to-physical mapping table in a non-volatile memory of the storage device of FIG. 1.

FIG. 4 is a conceptual diagram illustrating various examples of thermal throttling in the storage device of FIG. 1.

FIG. 5 is a conceptual diagram illustrating relocation of data between blocks of the storage device in different dies at different transfer rates.

FIG. 6 is a conceptual diagram illustrating various examples of different transfer rates with thermal throttling in the storage device of FIG. 1.

FIG. 7 is a flow chart illustrating an exemplary method for setting different transfer rates with thermal throttling in a storage device.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

The words “exemplary” and “example” are used herein to mean serving as an example, instance, or illustration. Any exemplary embodiment described herein as “exemplary” is not necessarily to be construed as preferred or advantageous over other exemplary embodiments. Likewise, the term “exemplary embodiment” of an apparatus, method or article of manufacture does not require that all exemplary embodiments of the invention include the described components, structure, features, functionality, processes, advantages, benefits, or modes of operation.

In the following detailed description, various aspects of a storage device in communication with a host device will be presented. These aspects are well suited for flash storage devices, such as SSDs and SD cards. However, those skilled in the art will realize that these aspects may be extended to all types of storage devices capable of storing data. Accordingly, any reference to a specific apparatus or method is intended only to illustrate the various aspects of the present invention, with the understanding that such aspects may have a wide range of applications without departing from the spirit and scope of the present disclosure.

Generally, a storage device including multiple dies of NAND cells may have a product operating temperature range sufficient to support the operating temperature of the cells. For example, a storage device including SLC and QLC blocks may support cross temperatures between −2 to 85° C. However, the maximum temperature of the NAND cells that can be reached, without compromising the integrity of stored data, may be less than the maximum cross temperature supported in certain types of blocks. For example, while SLC blocks may support a maximum temperature of 95° C., QLC blocks may only support a maximum temperature of 70° C. When the temperature of NAND cells increases beyond the maximum reliable operating temperature for a block (e.g. 70° C. for QLC blocks), the storage device may reduce the temperature by disabling parallel access to the dies. Although the QLC blocks may thus maintain their data integrity as a result of this temperature throttling, device performance may still be reduced since the SLC blocks would also be affected well below their maximum reliable temperature. The result effectively reduces the storage device's operating range (of SLCs and QLCs) to only the maximum reliable temperature of the QLCs and affects the user experience by impacting storage device performance.

To effectively increase the storage device's operating temperature range and improve the overall user experience, the present disclosure allows the storage device to factor temperature throttling into a load balancing process, such as garbage collection. When the storage device receives write commands from a host device, the storage device stores the data directly in SLC blocks. As the number of free SLC blocks decreases, the storage device relocates the data in SLC blocks to QLC blocks (or other MLC blocks). This relocation may increase the temperature of the QLC blocks. As the temperature of the QLC blocks increases beyond various temperature thresholds, the storage device increasingly throttles parallel access to the dies including the QLC blocks to preserve data integrity. As a result, to improve device performance, as the temperature of the QLC blocks increases beyond the temperature thresholds, the storage device also relocates the data from SLC blocks to the QLC blocks at higher transfer rates associated with each threshold, freeing up additional space faster in the SLC blocks. Once the QLC block temperature increases to a maximum write threshold, the storage device disables data relocation from the SLC blocks to preserve data reliability. Nevertheless, while access is limited to the QLC blocks due to the temperature throttling, the storage device may write data to the freed up SLC blocks until the QLC blocks decrease in temperature back below the temperature thresholds, at which point the storage device may decrease the transfer rate and the temperature throttling. As a result, the storage device allows more SLC blocks to be available for writing even when the QLC blocks have exceeded their reliable operating temperature, improving the user experience in storage device performance while maintaining reliability of the data from temperature throttling.

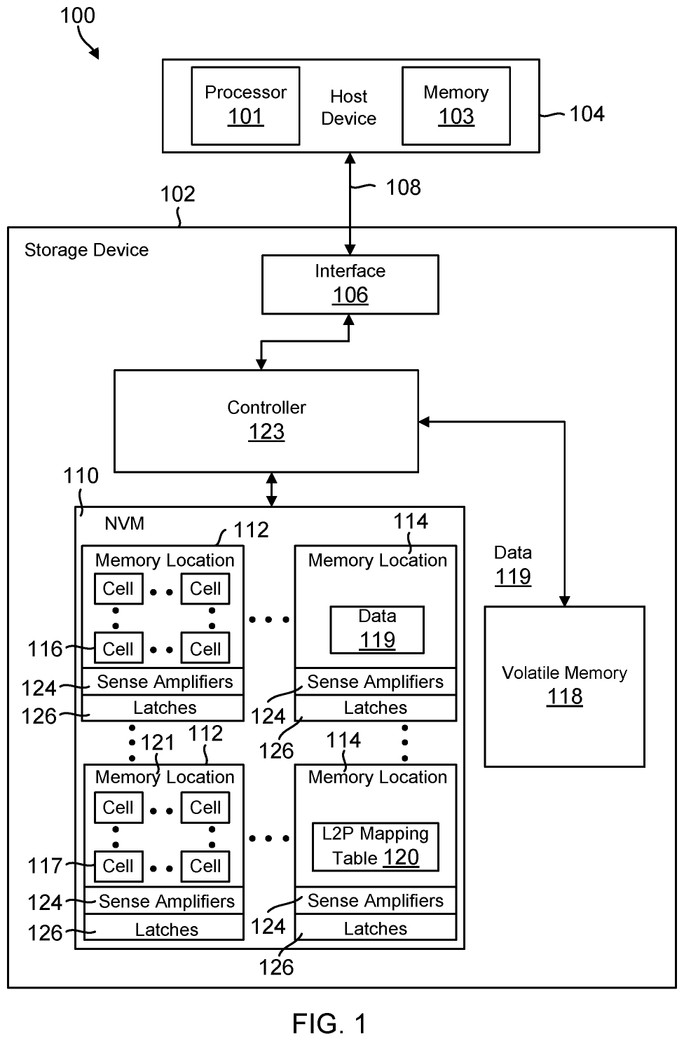

FIG. 1 shows an exemplary block diagram 100 of a storage device 102 which communicates with a host device 104 (also “host”) according to an exemplary embodiment. The host 104 and the storage device 102 may form a system, such as a computer system (e.g., server, desktop, mobile/laptop, tablet, smartphone, etc.). The components of FIG. 1 may or may not be physically co-located. In this regard, the host 104 may be located remotely from storage device 102. Although FIG. 1 illustrates that the host 104 is shown separate from the storage device 102, the host 104 in other embodiments may be integrated into the storage device 102, in whole or in part. Alternatively, the host 104 may be distributed across multiple remote entities, in its entirety, or alternatively with some functionality in the storage device 102.

Those of ordinary skill in the art will appreciate that other exemplary embodiments can include more or less than those elements shown in FIG. 1 and that the disclosed processes can be implemented in other environments. For example, other exemplary embodiments can include a different number of hosts communicating with the storage device 102, or multiple storage devices 102 communicating with the host(s).

The host device 104 may store data to, and/or retrieve data from, the storage device 102. The host device 104 may include any computing device, including, for example, a computer server, a network attached storage (NAS) unit, a desktop computer, a notebook (e.g., laptop) computer, a tablet computer, a mobile computing device such as a smartphone, a television, a camera, a display device, a digital media player, a video gaming console, a video streaming device, or the like. The host device 104 may include at least one processor 101 and a host memory 103. The at least one processor 101 may include any form of hardware capable of processing data and may include a general purpose processing unit (such as a central processing unit (CPU)), dedicated hardware (such as an application specific integrated circuit (ASIC)), digital signal processor (DSP), configurable hardware (such as a field programmable gate array (FPGA)), or any other form of processing unit configured by way of software instructions, firmware, or the like. The host memory 103 may be used by the host device 104 to store data or instructions processed by the host or data received from the storage device 102. In some examples, the host memory 103 may include non-volatile memory, such as magnetic memory devices, optical memory devices, holographic memory devices, flash memory devices (e.g., NAND or NOR), phase-change memory (PCM) devices, resistive random-access memory (ReRAM) devices, magnetoresistive random-access memory (MRAM) devices, ferroelectric random-access memory (F-RAM), and any other type of non-volatile memory devices. In other examples, the host memory 103 may include volatile memory, such as random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, and the like). The host memory 103 may also include both non-volatile memory and volatile memory, whether integrated together or as discrete units.

The host interface 106 is configured to interface the storage device 102 with the host 104 via a bus/network 108, and may interface using, for example, Ethernet or WiFi, or a bus standard such as Serial Advanced Technology Attachment (SATA), PCI express (PCIe), Small Computer System Interface (SCSI), or Serial Attached SCSI (SAS), among other possible candidates. Alternatively, the host interface 106 may be wireless, and may interface the storage device 102 with the host 104 using, for example, cellular communication (e.g. 5G NR, 4G LTE, 3G, 2G, GSM/UMTS, CDMA One/CDMA2000, etc.), wireless distribution methods through access points (e.g. IEEE 802.11, WiFi, HiperLAN, etc.), Infra Red (IR), Bluetooth, Zigbee, or other Wireless Wide Area Network (WWAN), Wireless Local Area Network (WLAN), Wireless Personal Area Network (WPAN) technology, or comparable wide area, local area, and personal area technologies.

As shown in the exemplary embodiment of FIG. 1, the storage device 102 includes non-volatile memory (NVM) 110 for non-volatilely storing data received from the host 104. The NVM 110 can include, for example, flash integrated circuits, NAND memory (e.g., single-level cell (SLC) memory, multi-level cell (MLC) memory, triple-level cell (TLC) memory, quad-level cell (QLC) memory, penta-level cell (PLC) memory, or any combination thereof), or NOR memory. The NVM 110 may include a plurality of memory locations 112 which may store system data for operating the storage device 102 or user data received from the host for storage in the storage device 102. For example, the NVM may have a cross-point architecture including a 2-D NAND array of memory locations 112 having n rows and m columns, where m and n are predefined according to the size of the NVM. In the illustrated exemplary embodiment of FIG. 1, each memory location 112 may be a block 114 including multiple cells 116, 117. The cells 116, 117 may be SLCs, MLCs, TLCs, QLCs, and/or PLCs. Different blocks 114 may contain different types of cells. For instance, cells 116 of one block 114 may be SLCs, while cells 117 of another block 114 may be QLCs. Alternatively, the cells of one block 114 may be different types, such as SLCs and QLCs. Other examples of memory locations 112 are possible; for instance, each memory location may be a die containing multiple blocks. Moreover, each memory location may include one or more blocks in a 3-D NAND array. Moreover, the illustrated memory locations 112 may be logical blocks which are mapped to one or more physical blocks.

The storage device 102 also includes a volatile memory 118 that can, for example, include a Dynamic Random Access Memory (DRAM) or a Static Random Access Memory (SRAM). Data stored in volatile memory 118 can include data read from the NVM 110 or data to be written to the NVM 110. In this regard, the volatile memory 118 can include a write buffer and a read buffer for temporarily storing data. While FIG. 1 illustrate the volatile memory 118 as being remote from a controller 123 of the storage device 102, the volatile memory 118 may be integrated into the controller 123.

The memory (e.g. NVM 110) is configured to store data 119 received from the host device 104. The data 119 may be stored in the cells 116, 117 of any of the memory locations 112. For example, in response to a write command from the host device 104 to store data, the data 119 may be written to one or more cells 116 of a block 114. The cells 116 may be SLCs, which each store one bit of data, or MLCs, which each store multiple bits of data. The blocks 114 may also be hybrid blocks in which one or more cells may store less bits than their maximum capacity; for example, one or more cells 116 of a block of MLCs may each be configured to store only one bit of data (e.g. like an SLC). When one or more blocks 114 of cells 116 becomes full, the data 119 stored in those cells 116 may be relocated to cells 117 in another block 114 during garbage collection. These cells 117 may each store more bits than the cells 116. For example, if cells 116 are SLCs, the cells 117 may be QLCs, or any type of MLC. Alternatively, the cells 117 may store the same number of bits as the cells 116.

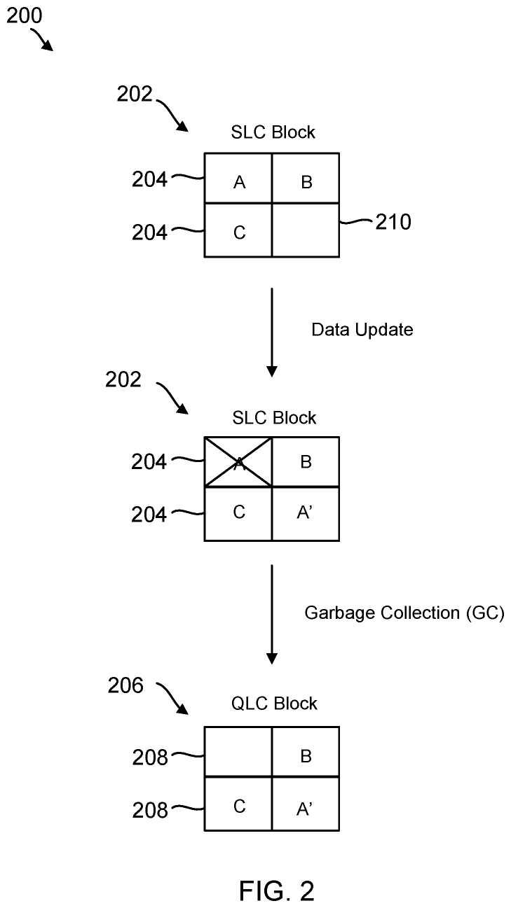

FIG. 2 is a conceptual diagram 200 of an example of a garbage collection process in which data stored in pages 204 of a block 202 of SLC cells are relocated to pages 208 of a block 206 of QLC cells. The data may correspond to the data 119 of FIG. 1, the blocks 202, 206 may correspond to the blocks 114 of FIG. 1, the SLC cells may correspond to the cells 116 of FIG. 1, and the QLC cells may correspond to the cells 117 of FIG. 1. Each page 204, 208 includes data stored in multiple cells along a same row or word line of the NVM. Thus, each page 204 may include data stored in a row of the cells 116 of one block, while each page 208 may include data stored in a row of the cells 117 of another block. For simplicity of illustration, the example of FIG. 2 illustrates the blocks 202, 206 each including only four pages 204, 208. However, it should be recognized that each block may include any number of pages.

In the example of FIG. 2, data represented by identifiers A, B, and C are stored in different pages 204 of the block 202. Originally, the data A, B, and C are stored in three pages of the block 202 in response to write commands from the host device, leaving one of the pages free in this example. When the storage device receives new or updated data, this data is stored in the free page 210. For example, updated data A′ may be received from the host device and written to the free page 210. Since data cannot be overwritten in flash memory, the invalid data A remains stored in the block 202. As a result of new data and invalid data, the block 202 may quickly become full.

To free space in the SLC block, original and updated data in the block 202 may be transferred to the block 206. The invalid data remain in the old block. For instance, in the example of FIG. 2, the original data B and C and the updated data A′ are read from the pages 204 of the block 202 and written to one or more pages 208 of the block 206. The invalid data A remains in the block 202. When the block 202 is subsequently erased, the invalid data is discarded, and the block 202 may be reused to store new data.

Each of the data may be associated with a logical address. For example, referring back to FIG. 1, the NVM 110 may store a logical-to-physical (L2P) mapping table 120 for the storage device 102 associating each data 119 with a logical address. The L2P mapping table 120 stores the mapping of logical addresses specified for data written from the host 104 to physical addresses in the NVM 110 indicating the location(s) where each of the data is stored. This mapping may be performed by the controller 123 of the storage device. The L2P mapping table may be a table or other data structure which includes an identifier such as a logical block address (LBA) associated with each memory location 112 in the NVM where data is stored. While FIG. 1 illustrates a single L2P mapping table 120 stored in one of the memory locations 112 of NVM to avoid unduly obscuring the concepts of FIG. 1, the L2P mapping table 120 in fact may include multiple tables stored in one or more memory locations of NVM.

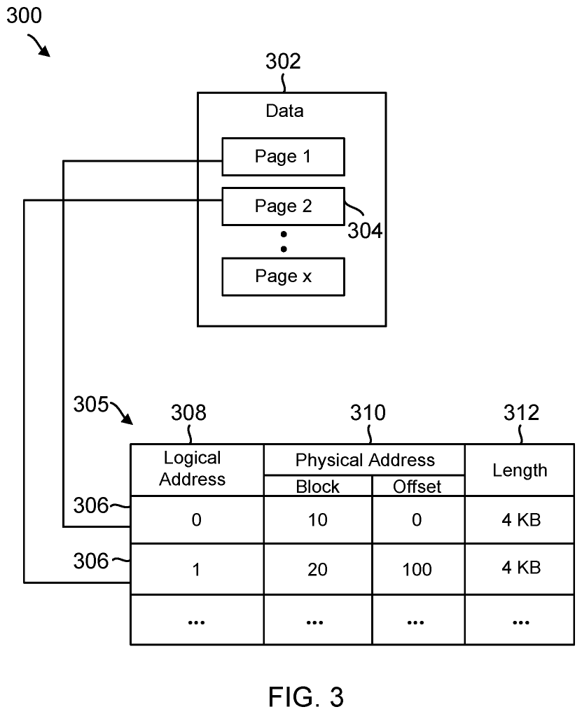

FIG. 3 is a conceptual diagram 300 of an example of an L2P mapping table 305 illustrating the mapping of data 302 received from a host device to logical addresses and physical addresses in the NVM 110 of FIG. 1. The data 302 may correspond to the data 119 in FIG. 1 and the data in FIG. 2 (e.g. A, B, C, A′, etc.), while the L2P mapping table 305 may correspond to the L2P mapping table 120 in FIG. 1. In one exemplary embodiment, the data 302 may be stored in one or more pages 304, e.g., pages 1 to x, where x is the total number of pages of data being written to the NVM 110. Each page 304 may be associated with one or more entries 306 of the L2P mapping table 305 identifying a logical block address (LBA) 308, a physical address 310 associated with the data written to the NVM, and a length 312 of the data. LBA 308 may be a logical address specified in a write command for the data received from the host device. Physical address 310 may indicate the block and the offset at which the data associated with LBA 308 is physically written. Length 312 may indicate a size of the written data (e.g. 4 KB or some other size).

Referring back to FIG. 1, the NVM 110 includes sense amplifiers 124 and data latches 126 connected to each memory location 112. For example, the memory location 112 may be a block including cells 116, 117 on multiple bit lines, and the NVM 110 may include a sense amplifier 124 on each bit line. Moreover, one or more data latches 126 may be connected to the bit lines and/or sense amplifiers. The data latches may be, for example, shift registers. When data is read from the cells 116, 117 of the memory location 112, the sense amplifiers 124 sense the data by amplifying the voltages on the bit lines to a logic level (e.g. readable as a ‘0’ or a ‘1’), and the sensed data is stored in the data latches 126. The data is then transferred from the data latches 126 to the controller 123, after which the data is stored in the volatile memory 118 until it is transferred to the host device 104. When data is written to the cells 116 of the memory location 112, the controller 123 stores the programmed data in the data latches 126, and the data is subsequently transferred from the data latches 126 to the cells 116, 117.

The storage device 102 includes a controller 123 which includes circuitry such as one or more processors for executing instructions and can include a microcontroller, a Digital Signal Processor (DSP), an Application-Specific Integrated Circuit (ASIC), a Field Programmable Gate Array (FPGA), hard-wired logic, analog circuitry and/or a combination thereof.

The controller 123 is configured to receive data transferred from one or more of the cells 116, 117 of the various memory locations 112 in response to a read command. The controller 123 is also configured to allocate a memory location 112 and to program data into one or more of the cells 116, 117 in response to a write command. The controller 123 is further configured to access the L2P mapping table 120 in the NVM 110 when reading or writing data to the cells 116, 117. For example, the controller 123 may receive logical-to-physical address mappings from the NVM 110 in response to read or write commands from the host device 104, identify the physical addresses mapped to the logical addresses identified in the commands, and access or store data in the cells 116, 117 located at the mapped physical addresses.

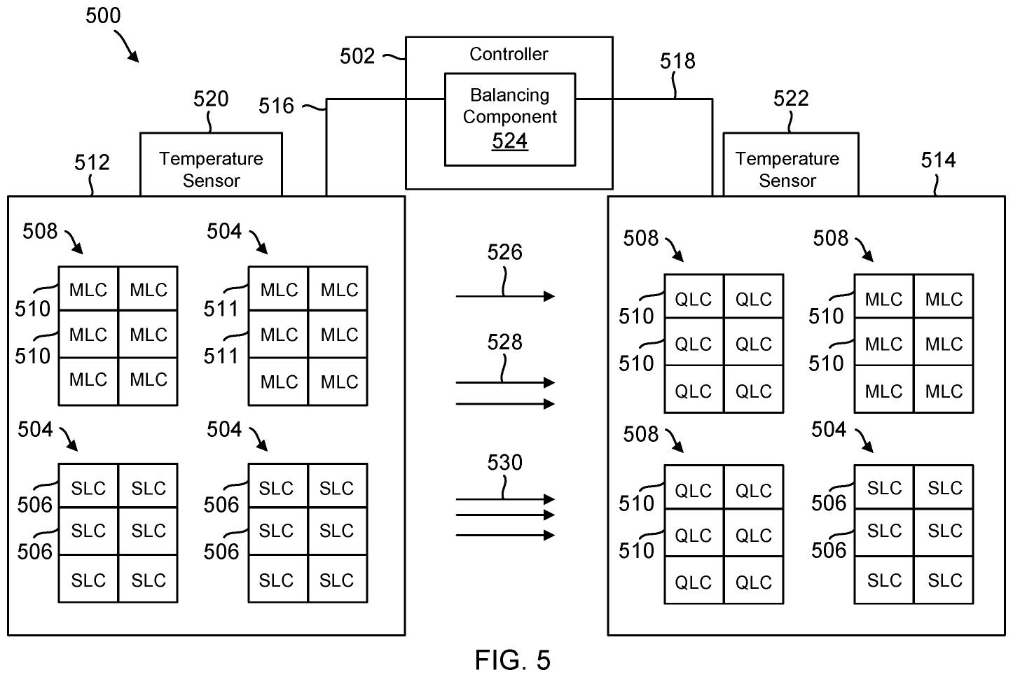

The controller 123 may be further configured to access the memory locations 112 in parallel. For example the memory locations 112 may be blocks 114 stored on different dies of the NVM 110, and each die may be connected to the controller 123 by its own data bus (as described below and illustrated in FIG. 5). The controller may read or write data to the cells 116, 117 on the different dies simultaneously over the multiple data buses. Additionally, the controller 123 may be configured to refrain from accessing the memory locations 112 in parallel, and may instead access the memory locations 112 serially. For example, the controller may determine to read or write data to the cells 116, 117 of a memory location 112 in sequence rather than simultaneously over the multiple data buses.

The controller 123 may also be configured to perform load balancing, such as garbage collection. For example, as described above with respect to FIG. 2, the controller 123 may transfer data stored in one or more memory locations 112 (e.g. a block of cells 116) to one or more other memory locations 112 (e.g. a block of cells 117). The controller 123 may then erase the block 114 of cells 116, thus freeing up space in the memory location to store new and updated data in response to write commands from the host device 104.

The controller 123 and its components may be implemented with embedded software that performs the various functions of the controller described throughout this disclosure. Alternatively, software for implementing each of the aforementioned functions and components may be stored in the NVM 110 or in a memory external to the storage device 102 or host device 104, and may be accessed by the controller 123 for execution by the one or more processors of the controller 123. Alternatively, the functions and components of the controller may be implemented with hardware in the controller 123, or may be implemented using a combination of the aforementioned hardware and software.

In operation, the host device 104 stores data in the storage device 102 by sending a write command to the storage device 102 specifying one or more logical addresses (e.g., LBAs) as well as a length of the data to be written. The interface element 106 receives the write command, and the controller allocates a memory location 112 in the NVM 110 of storage device 102 for storing the data. The controller 123 stores the L2P mapping in the NVM to map a logical address associated with the data to the physical address of the memory location 112 allocated for the data. The controller also stores the length of the L2P mapped data. The controller 123 then stores the data in the memory location 112 by sending it to one or more data latches 126 connected to the allocated memory location, from which the data is programmed to the cells 116.

The host 104 may retrieve data from the storage device 102 by sending a read command specifying one or more logical addresses associated with the data to be retrieved from the storage device 102, as well as a length of the data to be read. The interface 106 receives the read command, and the controller 123 accesses the L2P mapping in the NVM to translate the logical addresses specified in the read command to the physical addresses indicating the location of the data. The controller 123 then reads the requested data from the memory location 112 specified by the physical addresses by sensing the data using the sense amplifiers 124 and storing them in data latches 126 until the read data is returned to the host 104 via the host interface 106.

When there are no empty cells 116 in the memory location 112 available for storing data, the controller 123 performs garbage collection or load balancing by transferring data from the cells 116 to available cells 117 in other memory locations 112. The controller 123 may then erase the memory location 112 including the cells 116. Once the cells 116 are free, the controller may continue to write data into the empty cells 116.

As the cells 117 are read or written or as the ambient temperature of the storage device 102 increases, the cells 117 may exceed their reliable operating temperatures, compromising data integrity. For example, the cells 117 may be QLCs with a maximum write temperature threshold of 70°. To prevent the temperature of these cells from exceeding the threshold and to preserve the integrity of the data, the storage device 102 may apply temperature throttling. As an example, the blocks 114 of cells 117 may be located on different dies, and the controller 123 may disable parallel access to the cells 117 on one or more of the dies, requiring the cells 117 to be accessed serially. The temperature of the cells 117 may thereby be reduced since the cells are accessed less frequently.

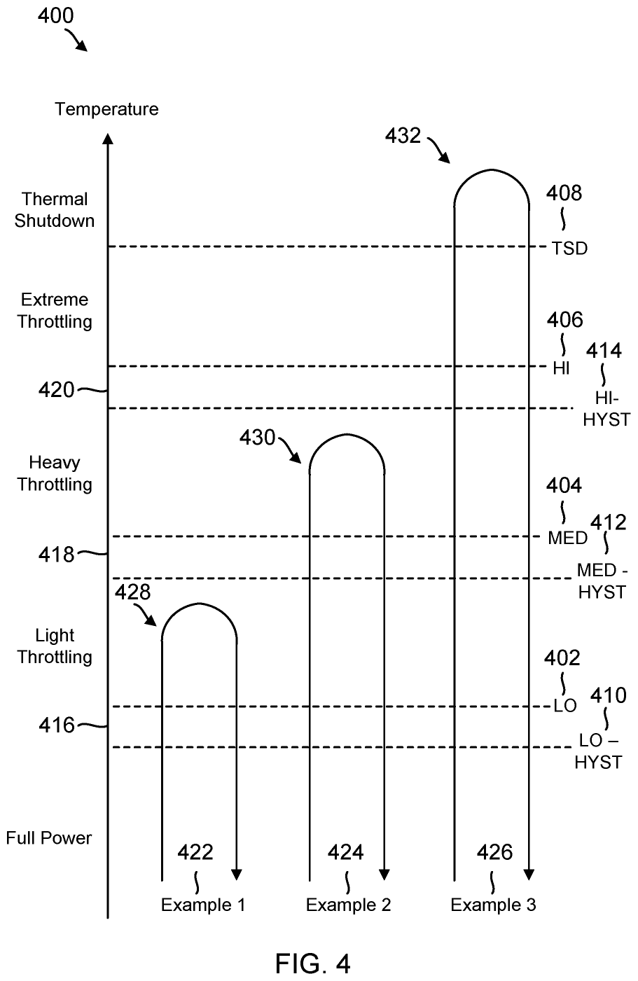

FIG. 4 illustrates an example diagram 400 of temperature throttling in a storage device. In temperature throttling, the controller increasingly limits access to the cells as the temperature rises in order to cool down the storage device. For example, the cells may be contained in one or more dies, and the controller may disable parallel access to an increasing number of dies as the temperature exceeds various thresholds. In the example diagram 400, several thresholds are configured for different levels of throttling, including a low (LO) threshold 402, a medium (MED) threshold 404, a high (HI) threshold 406, and a thermal shut down (TSD) threshold 408. For example, in the case of QLC temperatures, LO threshold 402 may be 55° or another degree, MED threshold 404 may be 60° or another degree, HI threshold 406 may be 65° or another degree, and TSD threshold 408 may be the maximum write temperature, e.g. 70°. These thresholds are merely examples; any number of temperature thresholds of varying degrees may be used. Moreover, the thresholds may change depending on the cell type. For instance, in the case of TLC temperatures, the thresholds may all be higher, while in the case of PLC temperatures, the thresholds may all be lower.

Additional thresholds may be configured to account for temperature hysteresis. For instance, in the example diagram 400, a low hysteresis (LO-HYST) threshold 410, a medium hysteresis (MED-HYST) threshold 412, and a high hysteresis (HI-HYST) threshold 414 are configured. The hysteresis thresholds prevent the storage device from switching back and forth between different levels of throttling as the temperature bounds across a single degree. For example, FIG. 4 illustrates hysteresis ranges 416, 418, 420 corresponding to each hysteresis threshold. While the temperature is within each hysteresis range, the prior throttling level is maintained, thereby avoiding wear and increasing the life of the storage device.

The controller may perform different levels of throttling as the temperature of the cells exceeds the various thresholds in order to more quickly reduce the temperature. For instance, when reducing die parallelism, the controller may apply light throttling (e.g. throttling one die) when the temperature exceeds the LO threshold 402, heavy throttling (e.g. throttling two dies) when the temperature exceeds the MED threshold 404, extreme throttling (e.g. throttling three dies) when the temperature exceeds the HI threshold 406, and thermal shutdown (e.g. shutting down access to the dies) when the temperature exceeds the TSD threshold 408. Other examples of throttling may be used; for instance, instead of disabling parallel access to one, two, or three dies, respectively, the storage device may disable parallel access to different numbers of dies, prevent reads or writes to different number of dies, restrict or limit access to different numbers or types of memory locations on the same die, or perform other temperature reducing schemes.

Accordingly, FIG. 4 illustrates various examples 422, 424, 426 of different throttling level operations as the temperature 428, 430, 432 of the cells rises, for example, due to read or write operations or ambient temperature increases. Referring to the first example 422, the storage device initially operates in full power, e.g. without throttling. When the temperature 428 exceeds the LO threshold 402, the controller performs light throttling. In this example, light throttling is sufficient to cause the temperature to taper off, and throttling is continued to be performed until the temperature decreases below the LO-HYST threshold 410. The storage device then disables throttling, resuming full power operation.

Referring to the second example 424, the storage device initially operates in full power without throttling. However, unlike the first example, when the temperature 430 exceeds the LO threshold 402, light throttling is insufficient to reduce the temperature, and so the temperature 430 continues to increase. When the temperature exceeds the MED threshold 404, the controller performs heavy throttling. In this example, heavy throttling is sufficient to cause the temperature to taper off, and throttling is continued to be performed until the temperature decreases below the MED-HYST threshold 412. At that point, the controller switches to light throttling, which is continued to be performed until the temperature decreases below the LO-HYST threshold 410. The storage device then disables throttling, resuming full power operation.

Referring to the third example 426, the storage device initially operates in full power without throttling. However, unlike the first and second examples, when the temperature 432 exceeds the LO threshold 402 and MED thresholds 404, light throttling and heavy throttling are insufficient to reduce the temperature, and so the temperature 432 continues to increase. When the temperature exceeds the HI threshold 406, the controller performs extreme throttling. In this example, extreme throttling is insufficient to cause the temperature to taper off, so the temperature continues to increase until it reaches the TSD threshold 408. At this point, the controller performs thermal shutdown, for instance, shutting down access to the cells and/or the storage device until the temperature decreases back to the normal level.

While temperature throttling, such as that described with respect to FIG. 4, may reduce the temperature of the storage device, it may also reduce system performance when the storage device includes multiple types of blocks of cells (e.g. SLCs, QLCs, etc.). For instance, referring back to FIG. 1, a block 114 of cells 116 which operate as SLCs may typically have a reliable operating temperature of at most 95°, while a block 114 of cells 117 which operate as QLCs may typically have a lower reliable temperature of at most 70°. To maximize data integrity, temperature throttling generally accounts for the lowest maximum temperature of the different cell types as the TSD threshold 408 (in this case, 70°). As a result, access to cell types with higher reliable temperatures may inefficiently be impacted by temperature throttling. For instance, if the temperature of a block 114 of cells 117 on a die which are QLCs increases across the various thresholds as described above in FIG. 4, disabling parallel access to the die may limit access to blocks 114 of cells 116 on the same die which are SLCs far from exceeding their reliable operating temperatures. Thus, device performance and user satisfaction may be reduced.

To improve device performance, the controller 123 may be configured to transfer data from cells 116 which store less bits (e.g. SLCs) to cells 117 which store more bits (e.g. QLCs) at different transfer rates depending on the temperature of the cells 117, as described below with respect to FIGS. 5-7. For example, the controller 123 may be configured to transfer the data at a higher transfer rate when the temperature of the cells 117 increases above a temperature threshold, and to transfer the data at a lower transfer rate when the temperature of the cells 117 decreases below the temperature threshold. The cells 116, 117 may be on different dies. Thus, if temperature throttling is applied limiting parallel access to the cells 117, the cells 116 may be made available for storing new or updated data at an increased rate.

The controller 123 may also be configured to disable transferring the data when the temperature reaches a maximum write temperature threshold for the cells 117. The controller 123 may further be configured to disable storing data in the cells 116 when a temperature of the cells 116 reaches a maximum temperature threshold, or when an amount of free space in the cells 116 reduces below a free space threshold. The controller 123 may further be configured to store data in the NVM 110 on different dies, and to identify the temperature of the cells 117 from a die having the highest temperature of the different dies. The controller 123 may throttle parallel access to the different dies when the temperature of the cells 117 is above the temperature threshold.

FIG. 5 illustrates an example diagram 500 of a controller 502 which transfers data between different types of blocks 504, 508 as a function of temperature. The blocks 508 may include cells which store more bits than the cells of the blocks 504. For example, blocks 504 may include pages 506 of SLCs, while blocks 508 may include pages 510 of QLCs or other types of MLCs (e.g. 2-bit cells, TLCs, PLCs, etc.). Blocks 504 may also include pages 511 of MLCs, where each MLC may be configured by the controller to store only one bit, e.g. as SLCs, in response to a write command. Referring to FIG. 1, the controller 502 may correspond to the controller 123, the blocks 504 of SLCs may correspond to the blocks 114 including cells 116, and the blocks 508 of MLCs (e.g. QLCs) may correspond to the blocks 114 including cells 117.

The blocks 504, 508 may be stored on one or more dies 512, 514. For instance, in the example of FIG. 5, a mix of the blocks 504, 508 are contained within one die 512, while a different mix of the blocks 504, 508 are contained within another die 514. The controller 502 may access each die 512, 514 in parallel using multiple data buses 516, 518. For example, when the controller 502 receives a read or write command from the host device for data on dies 512, 514, the controller may receive data in pages on each bus 516, 518 simultaneously from the blocks 504, 508. Alternatively, the controller may receive data serially from the blocks 504, 508. The blocks 504, 508 may be accessible by the controller 502 in parallel on different dies 512, 514, or may be accessible in parallel on a single die.

The controller 502 may communicate with one or more temperature sensors 520, 522 coupled to the one or more dies 512, 514. The controller 502 may determine the temperature of the cells in the blocks 504, 508 based on readings from the temperature sensors. Upon determining the temperature, the controller 502 may apply temperature throttling to the dies 512, 514 as described above with respect to FIG. 4. For example, if the MLC (e.g. QLC) cells in a block 508 exceed one of the aforementioned temperature thresholds 402, 404, 406, 408 of FIG. 4, the controller 502 may limit parallel access to the die 512, 514 to reduce the temperature of the block(s) 508. As an example, when the controller 502 receives a read command or a write command from the host device, the controller may refrain from receiving or sending data on the bus 518 at the same time as data on the bus 516. The controller 502 may alternatively apply temperature throttling in other ways. For example, if the blocks 504, 508 contained on a single die are accessible in parallel, the controller may refrain from receiving or sending data simultaneously to the blocks 504, 508.

The controller 502 may include a balancing module or component 524 which is configured to transfer or relocate data between the blocks 504 and the blocks 508. The balancing component 524 may be referred to as a Maintenance eViction Planner (MVP) or another name. The balancing component 524 may balance the storage of data (e.g. transfer/relocate data) between the blocks 504 and 508, for example, during garbage collection, as described above with respect to FIG. 2.

The balancing component 524 may operate in multiple states, including a background state, a foreground state, an extreme state, and an emergency state. The balancing component 524 may switch between the different states depending on the availability of the blocks, e.g., the blocks 504 of SLCs. The controller 502 may determine the availability of SLC blocks, for example, by counting the pages 506 in the L2P mapping table 120, 305 of FIGS. 1 and 3. If the controller 502 determines that the there is a large pool of free SLC blocks 504 (e.g. 75% or more of blocks 504 are free), the controller may switch the balancing component 524 to the background state, in which case the balancing component 524 may transfer data between the blocks 504, 508 while the controller freely executes read and write commands. If the controller 502 determines that there is a sufficient pool of free SLC blocks 504 for read and write operations (e.g. 50-75% of blocks 504 are free), the controller may switch the balancing component 524 to the foreground state, in which the balancing component 524 transfers data between the blocks 504, 508 before the controller executes a subsequent read or write command. If the controller 502 determines that there is reduced number of free SLC blocks 504 (e.g. 25%-50% of blocks 504 are free), the controller may switch the balancing component to the extreme state, in which the balancing component 524 transfers data between the blocks 504, 508 until the number of free SLC blocks 504 increases to a specified amount before the controller again executes read or write commands. If the controller 502 determines that there is a critical number of free SLC blocks 504 (e.g. 0%-25% of blocks 504 are free), the controller may switch the balancing component to the emergency state, in which the controller may shut down writes to the blocks 504 and transfer data between the blocks 504, 508 until the number of free SLC blocks 504 increases to the specified amount.

While the balancing component 524 may switch between the aforementioned states based on the available number of free blocks 504 (or 508) as the controller 502 executes read or write commands from the host device, the balancing component 524 may further switch between the states based on the temperature of the blocks 504, 508 sensed by the temperature sensors 520, 522. For instance, the balancing component 524 may transfer data between the blocks 504, 508 in the different states and at different transfer rates depending on the temperature sensed by the temperature sensors. As an example, if the controller 502 determines that the temperature of the blocks 508 of MLC (e.g. QLC) cells is increasing towards a maximum write temperature threshold (e.g. 70°), the balancing component 524 may switch to the emergency state. As another example, if the controller 502 determines that the temperature of the blocks 508 increases beyond the temperature thresholds 402, 404, 406 of FIG. 4, the balancing component 524 may proportionally increase the transfer rate between blocks 504, 508. Referring to FIG. 5 for instance, the balancing component 524 may transfer the data from blocks 504 to blocks 508 at a first transfer rate 526 when the temperature sensed by the temperature sensor 522 exceeds the LO threshold 402, at a second transfer rate 528 higher than the first transfer rate when the sensed temperature exceeds the MED threshold 404, and at a third transfer rate 530 higher than the second transfer rate when the sensed temperature exceeds the HI threshold 406. The controller 502 may also disable transferring of data from the blocks 504 to the blocks 508 when the sensed temperature exceeds the TSD threshold 408. In this way, the amount of free blocks 504 may be increasingly used for data storage even when the blocks 508 have exceeded their reliable operating temperature.

The aforementioned functions performed by the balancing component is not limited to the specific component described, but may be implemented by different components or other components of the controller 123, 502.

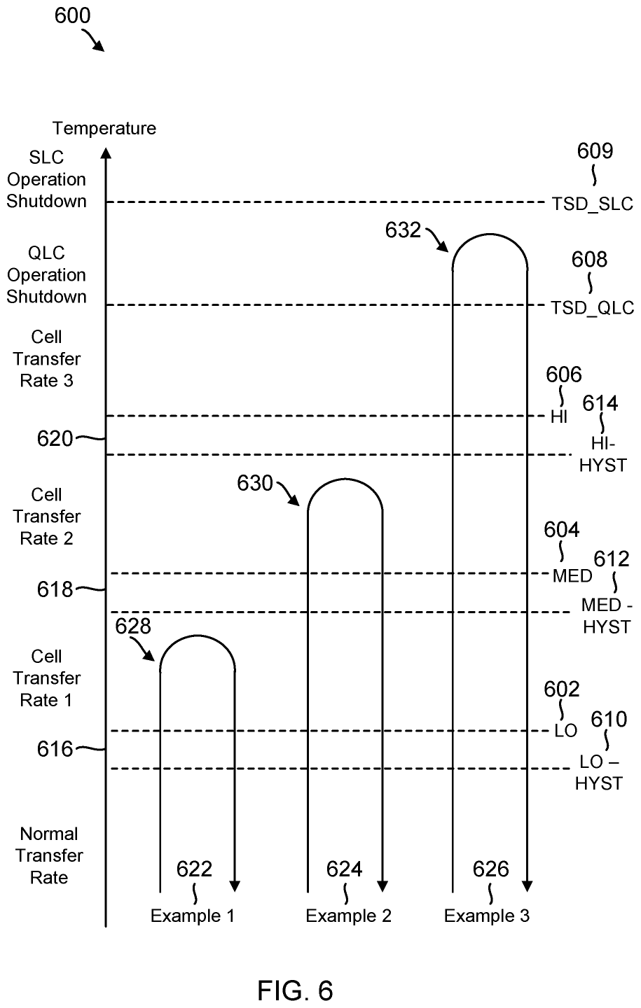

FIG. 6 illustrates an example diagram 600 illustrating increased cell transfer rates in combination with temperature throttling. The cells may correspond to the cells in the blocks 504, 508 of FIG. 5, and the temperature throttling may be similar to that described in FIG. 4. In the example diagram 600, several thresholds are configured for different levels of throttling, including a low (LO) threshold 602, a medium (MED) threshold 604, a high (HI) threshold 606, a QLC thermal shut down (TSD_QLC) threshold 608 and a SLC thermal shut down (TSD_SLC) threshold 609. The thresholds 602, 604, 606, 608/609 may correspond to the thresholds 402, 404, 406, and 408 in FIG. 4. For example, in the case of QLC temperatures, LO threshold 602 may be 55° or another degree, MED threshold 604 may be 60° or another degree, HI threshold 606 may be 65° or another degree, TSD_QLC threshold 608 may be the maximum write temperature for QLC cells, e.g. 70°, and TSD_SLC threshold 609 may be the maximum write temperature for SLC cells, e.g., 95°. Additional thresholds may be configured to account for temperature hysteresis. For instance, in the example diagram 600, a low hysteresis (LO-HYST) threshold 610, a medium hysteresis (MED-HYST) threshold 612, and a high hysteresis (HI-HYST) threshold 614 are configured, including hysteresis ranges 616, 618, 620 corresponding to each hysteresis threshold. The thresholds 610, 612, 614 and ranges 616, 618, 620 may correspond to the thresholds 410, 412, 414 and ranges 416, 418, 420 in FIG. 4. These thresholds are merely examples; any number of temperature thresholds of varying degrees may be used. Moreover, the thresholds may change depending on the cell type. For instance, in the case of TLC temperatures, the thresholds may all be higher, while in the case of PLC temperatures, the thresholds may all be lower.

While the controller performs temperature throttling, the controller may transfer data between cells (e.g. from the SLC cells of blocks 504 to the QLC cells of blocks 508 in FIG. 5) at different transfer rates as the temperature of the cells exceeds the various thresholds in order to more quickly increase available SLC block pools. For instance, the controller may apply a first transfer rate (e.g. transfer rate 526) when the temperature exceeds the LO threshold 602, a second transfer rate (e.g. transfer rate 528) when the temperature exceeds the MED threshold 604, a third transfer rate (e.g. transfer rate 530) when the temperature exceeds the HI threshold 606, QLC operation shutdown (e.g. shutting down access to the QLC cells) when the temperature exceeds the TSD_QLC threshold 608, and SLC operation shutdown (e.g. shutting down access to the SLC cells) when the temperature exceeds the TSD_SLC threshold 609. Other examples of cell operation shutdown may be used; for instance, if the cells of blocks 508 are TLCs, the TSD_QLC threshold 608 may be replaced with a corresponding temperature threshold for TLCs, and if the cells of blocks 504 are MLCs, the TSD_SLC threshold 609 may be replaced with a corresponding temperature threshold for MLCs.

Accordingly, FIG. 6 illustrates various examples 622, 624, 626 of different transfer rate operations as the temperature 628, 630, 632 of the cells rises, for example, due to read or write operations or ambient temperature increases. Referring to the first example 622, the controller initially relocates cells (e.g. from SLCs to QLCs) at a normal transfer rate and without throttling. The normal transfer rate may be a transfer rate which is generally used in conventional storage devices. When the temperature 628 exceeds the LO threshold 602, the controller increases the transfer rate to a first transfer rate higher than the normal transfer rate, while performing light throttling. In this example, light throttling is sufficient to cause the temperature to taper off, and relocation at the first transfer rate is continued to be performed until the temperature decreases below the LO-HYST threshold 610. The storage device then disables throttling, resuming operation at the normal transfer rate.

Referring to the second example 624, the storage device initially relocates cells at a normal transfer rate and without throttling. However, unlike the first example, when the temperature 630 exceeds the LO threshold 602, light throttling is insufficient to reduce the temperature, and so the temperature 630 continues to increase. When the temperature exceeds the MED threshold 604, the controller increases the transfer rate to a second transfer rate higher than the first transfer rate, while performing heavy throttling. In this example, heavy throttling is sufficient to cause the temperature to taper off, and relocation at the second transfer rate is continued to be performed until the temperature decreases below the MED-HYST threshold 612. At that point, the controller switches back to the first transfer rate with light throttling, which are continued to be performed until the temperature decreases below the LO-HYST threshold 610. The storage device then disables throttling, resuming operation at the normal transfer rate.

Referring to the third example 626, the storage device initially relocates cells at a normal transfer rate and without throttling. However, unlike the first and second examples, when the temperature 632 exceeds the LO threshold 602 and MED thresholds 604, light throttling and heavy throttling are insufficient to reduce the temperature, and so the temperature 632 continues to increase. When the temperature exceeds the HI threshold 606, the controller increases the transfer rate to a third transfer rate higher than the second transfer rate, while performing extreme throttling. In this example, extreme throttling is insufficient to cause the temperature to taper off, so the temperature continues to increase until it reaches the TSD_QLC threshold 608. At this point, the controller performs thermal shutdown of the QLC cells, for instance, preventing further data transfers to the cells of the blocks 508 of FIG. 5 until the temperature decreases back to the normal level. However, due to the increased transfer rates, additional free space is available in the SLC cells, and data may still be stored in the cells of the blocks 504 until the temperature reaches the TSD_SLC threshold 609, at which point a graceful shutdown (GSD) of the storage device may occur.

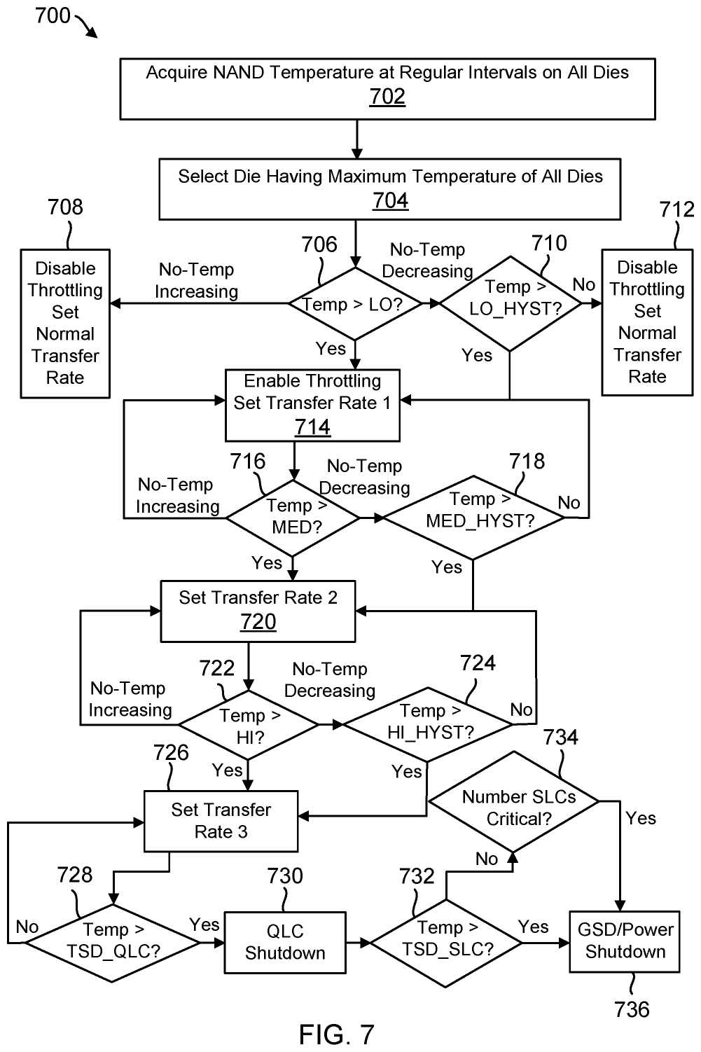

FIG. 7 is a flowchart 700 illustrating an exemplary embodiment of a method for increasing a transfer rate between cells as described in the examples of FIG. 6. For example, the method can be carried out in a storage device 102, such as the one illustrated in FIG. 1. Each of the steps in the flow chart can be controlled using the controller as described below (e.g. controller 123, 502), or by some other suitable means.

As represented by block 702, the controller may acquire a temperature of the NAND cells at regular intervals over all dies in the memory. For example, referring to FIGS. 1, 5 and 6, the controller 123, 502 may acquire a temperature 628, 630, 632 sensed by the temperature sensors 520, 522 from the dies 512, 514 in the NVM 110. The controller 123, 502 may acquire the temperature at regular intervals, for example, periodically every minute or other amount of time.

As represented by block 704, the controller may select a die having the maximum temperature of all dies. For example, referring to FIGS. 1, 5, and 6, after acquiring the temperature 628, 630, 632 sensed by the temperature sensors 520, 522, the controller 123, 502 may identify the die 514 to have a higher temperature than the die 512. The controller may subsequently perform temperature throttling of the blocks 508 on that die 514 and increase the transfer rate of data from the blocks 504 to that die 514.

As represented by decision block 706, the controller may determine if the temperature 628, 630, 632 is greater than a LO threshold 602. If not, and the temperature is increasing, then as represented by block 708, the controller disables temperature throttling and sets a normal transfer rate, as described above with respect to FIG. 6. If the temperature is decreasing, however, then as represented by decision block 710, the controller may determine if the temperature 628, 630, 632 is greater than a LO-HYST threshold 610. If not, then as represented by block 712, the controller disables temperature throttling and sets a normal transfer rate, as described above with respect to FIG. 6. Otherwise, as represented in block 714, the controller enables or continues to enable temperature throttling (e.g. light throttling), and sets the first transfer rate as described above with respect to FIGS. 5 and 6 (e.g. first transfer rate 526).

As represented by decision block 716, the controller may determine if the temperature 628, 630, 632 is greater than a MED threshold 604. If not, and the temperature is increasing, then as represented by block 714, the controller continues to enable temperature throttling and maintains the first transfer rate, as described above with respect to FIG. 6. If the temperature is decreasing, however, then as represented by decision block 718, the controller may determine if the temperature 628, 630, 632 is greater than a MED-HYST threshold 612. If not, then as represented by block 714, the controller continues to enable temperature throttling and sets the first transfer rate, as described above with respect to FIG. 6. Otherwise, as represented in block 720, the controller applies temperature throttling (e.g. heavy throttling), and sets the second transfer rate as described above with respect to FIGS. 5 and 6 (e.g. second transfer rate 528).

As represented by decision block 722, the controller may determine if the temperature 628, 630, 632 is greater than a HI threshold 606. If not, and the temperature is increasing, then as represented by block 720, the controller maintains the second transfer rate, as described above with respect to FIG. 6. If the temperature is decreasing, however, then as represented by decision block 724, the controller may determine if the temperature 628, 630, 632 is greater than a HI-HYST threshold 614. If not, then as represented by block 720, the controller maintains the second transfer rate, as described above with respect to FIG. 6. Otherwise, as represented in block 726, the controller applies temperature throttling (e.g. extreme throttling), and sets the third transfer rate as described above with respect to FIGS. 5 and 6 (e.g. third transfer rate 530).

As represented by decision block 728, the controller may determine if the temperature 628, 630, 632 is greater than a TSD_QLC threshold 608. If not, then as represented by block 726, the controller maintains the third transfer rate, as described above with respect to FIG. 6. Otherwise, as represented in block 730, the controller disables access to the QLC cells (e.g. the cells in blocks 508) until the temperature of the QLC cells reduces back to a reliable operating temperature range. As represented by decision blocks 732 and 734, the controller may also determine if the temperature 628, 630, 632 is greater than a TSD_SLC threshold 609 or if the number of available SLCs is at a critical level. For example, the controller may determine that the temperature of the cells in block 504 may reach a maximum temperature threshold for those cells (e.g. 95°), or that an amount of free space available in those cells is reduced below a free space threshold (e.g. 25% of all SLCs). If either condition is true, then as represented by block 736, the controller may perform a graceful shutdown of power to the storage device or otherwise restrict access to the SLCs.

Accordingly the present disclosure improves the performance of the storage device, and thereby improves the user experience of the storage device, without compromising data integrity. By transferring data to blocks of NAND cells (e.g. QLCs) at increased rates when the ambient temperature of the storage device reaches one or more thresholds of the NAND cells, the controller may continue to maximize device operation by allowing reads and writes to occur to other NAND cells with higher reliable operating temperatures even when temperature throttling is applied. The controller may selectively relocate, route or fold data at different rates between different types of NAND cells (e.g. SLCs and QLCs) at various temperatures. As a result, device performance is improved and data reliability is maintained.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) in the United States, or an analogous statute or rule of law in another jurisdiction, unless the element is expressly recited using the phrase “means for” or, in the case of a method claim, the element is recited using the phrase “step for.”

1. A storage device, comprising:
memory having a plurality of first and second cells, each of the second cells being configured to store more bits than each of the first cells;
a sensor configured to measure a temperature of the first cells or the second cells; and
a controller configured to store data in the first cells in response to a write command from a host device, the controller being further configured to transfer the data from the first cells to the second cells at a higher transfer rate when a measured temperature of the second cells is above a temperature threshold than when below the temperature threshold.

2. The storage device of claim 1, wherein the controller is configured to disable transferring the data from the first cells to the second cells when the temperature reaches a maximum write temperature threshold for the second cells.

3. The storage device of claim 2, wherein the controller is further configured to disable storing the data in the first cells when a temperature of the first cells reaches a maximum temperature threshold for the first cells or when an amount of free space in the first cells reduces below a free space threshold.

4. The storage device of claim 1, wherein the first cells comprise single level cells (SLCs), and wherein the second cells comprise one of multiple level cells (MLCs), triple level cells (TLCs), quad level cells (QLCs), or penta level cells (PLCs).

5. The storage device of claim 1, wherein the first cells comprise multiple level cells (MLCs), and the controller is configured to store one bit in each of the MLCs.

6. The storage device of claim 1, wherein the controller is configured to store data in the memory on different dies, and the controller is further configured to identify the temperature of the second cells from a die having a highest temperature of the different dies.

7. The storage device of claim 6, wherein the controller is further configured to throttle parallel access to the different dies when the temperature of the second cells is above the temperature threshold.

8. A storage device, comprising:
memory having a plurality of first and second cells, each of the second cells being configured to store more bits than each of the first cells;
a sensor configured to measure a temperature of the first cells or the second cells; and
a controller configured to store data in the first cells in response to a write command from a host device, the controller being further configured to transfer the data from the first cells to the second cells at a first transfer rate when a measured temperature of the second cells is below a temperature threshold and at a second transfer rate higher than the first transfer rate when the temperature is above the temperature threshold.

9. The storage device of claim 8, wherein the temperature threshold comprises a first temperature threshold, and wherein the controller is configured to transfer the data from the first cells to the second cells at a third transfer rate higher than the second transfer rate when the temperature is above a second temperature threshold higher than the first temperature threshold.

10. The storage device of claim 8, wherein the controller is configured to disable transferring the data from the first cells to the second cells when the temperature reaches a maximum write temperature threshold for the second cells.

11. The storage device of claim 10, wherein the controller is further configured to disable storing the data in the first cells when a temperature of the first cells reaches a maximum temperature threshold for the first cells or when an amount of free space in the first cells reduces below a free space threshold.

12. The storage device of claim 8, wherein the controller is configured to store data in the memory on different dies, and the controller is further configured identify the temperature of the second cells from a die having a highest temperature of the different dies.

13. The storage device of claim 12, wherein the controller is further configured to throttle parallel access to the different dies when the temperature of the second cells is above the temperature threshold.

14. A storage device, comprising:
memory having a plurality of first and second cells, each of the second cells being configured to store more bits than each of the first cells;
a sensor configured to measure a temperature of the first cells or the second cells; and
a controller configured to store data in the first cells in response to a write command from a host device, the controller being further configured to transfer the data from the first cells to the second cells at a transfer rate, wherein the transfer rate is a function of a measured temperature of the second cells such that the transfer rate is higher when the temperature is above a threshold and lower when the temperature is below the threshold.

15. The storage device of claim 14, wherein the controller is configured to disable transferring the data from the first cells to the second cells when the temperature reaches a maximum write temperature threshold for the second cells.

16. The storage device of claim 15, wherein the controller is further configured to disable storing the data in the first cells when a temperature of the first cells reaches a maximum temperature threshold for the first cells or when an amount of free space in the first cells reduces below a free space threshold.

17. The storage device of claim 14, wherein the first cells comprise single level cells (SLCs), and wherein the second cells comprise one of multiple level cells (MLCs), triple level cells (TLCs), quad level cells (QLCs), or penta level cells (PLCs).

18. The storage device of claim 14, wherein the first cells comprise multiple level cells (MLCs), and the controller is configured to store one bit in each of the MLCs.

19. The storage device of claim 14, wherein the controller is configured to store data in the memory on different dies, and the controller is further configured identify the temperature of the second cells from a die having a highest temperature of the different dies.

20. The storage device of claim 19, wherein the controller is further configured to throttle parallel access to the different dies when the temperature of the second cells is above a temperature threshold.
